(19) United States
(12) Patent Application Publication
(10) Pub. No.: US 2020/0393996 A1
(43) Pub. Date: Dec. 17, 2020

(54) INFORMATION PROCESSING DEVICE, INFORMATION PROCESSING SYSTEM, AND INFORMATION PROCESSING METHOD

(71) Applicants: CITIZEN WATCH CO., LTD., Nishitokyo-shi, Tokyo (JP); CITIZEN SYSTEMS JAPAN CO., LTD., Nishitokyo-shi, Tokyo (JP)

(72) Inventor: Akihiro KOSEKI, Hino-shi, Tokyo (JP)

(73) Assignees: CITIZEN WATCH CO., LTD., Nishitokyo-shi, Tokyo (JP); CITIZEN SYSTEMS JAPAN CO., LTD., Nishitokyo-shi, Tokyo (JP)

(21) Appl. No.: 16/961,925

(22) PCT Filed: Jan. 17, 2019
(86) PCT No.: PCT/JP2019/001269

§ 371 Date: Jul. 14, 2020

(30) Foreign Application Priority Data
Feb. 2, 2018 (JP) 2018-017607

(51) Int. Cl. G06F 3/06; G06K 7/10; G07G 1/00; G06F 13/16

(52) U.S. Cl. CPC G06F 3/0659; G06F 3/0679; G06F 3/0656; G06F 13/1673; G06K 7/10; G07G 1/009; G06F 3/061

(57) ABSTRACT

For improving the convenience of technology for processing data from a reading device with improved convenience, an information processing device having a communication function includes a controller unit configured to store reading data in a storage unit each time the reading data read by a reading device is received, and to transmit a plurality of the reading data stored in the storage unit to a terminal device when a first command is received from the terminal device.

### TECHNICAL FIELD

The present disclosure relates to information processing device, information processing system, and information processing method.

### BACKGROUND

Conventionally, there is known a technique for processing data read by a reading device, such as a barcode scanner. For example, PTL 1 discloses a POS system in which reading results of a barcode scanner is transmitted to a POS server via a control device and a tablet terminal.

### CITATION LIST

### Patent Literature

PTL 1: JP 2014-146290 A

### SUMMARY

### Technical Problem

Conventionally, in an information processing device that processes data read by a reading device, it has been a generally adopted measure to store the data in a memory and, in response to a request from a terminal device such as a computer, to read the data stored in the memory and transmit the data to the terminal device. However, a conventional information processing device generally transmits one data in response to one request from the terminal device. Therefore, for example, when a large number of data is stored in the memory, there may occur such inconveniences that the number of times of communication between the information processing device and the terminal device increases, or the operation burden of the user using the terminal device increases. For this reason, the convenience of the prior art for processing data from the reading device is not always high.

The present disclosure has been conceived in view of such circumstances, and it is an object to provide an information processing device, an information processing system, and an information processing method, capable of improving the convenience of the technology for processing data from a reading device.

### Solution to Problem

According to one embodiment of the present disclosure, there is provided an information processing device having a communication function, comprising:

a controller unit configured to store reading data in a storage unit each time the reading data read by a reading device is received, and to transmit a plurality of the reading data stored in the storage unit to a terminal device when a first command is received from the terminal device.

According to one embodiment of the present disclosure, there is also provided an information processing system comprising a reading device and an information processing device having a communication function, wherein:

the reading device is configured to read reading data and transmit the reading data to the information processing device; and

the information processing device is configured to store reading data in a storage unit each time the reading data is received, and to transmit a plurality of the reading data stored in the storage unit to a terminal device when a first command is received from the terminal device.

According to one embodiment of the present disclosure, there is further provided information processing method executable by an information processing device having a communication function, wherein the method comprises:

storing the reading data in a storage unit each time the reading data read by a reading device is received; and

transmitting a plurality of the reading data stored in the storage unit to a terminal device when a first command is received from the terminal device.

### Advantageous Effect

With the information processing device, the information processing system, and the information processing method according to one embodiment of the present disclosure, it is possible to improve the convenience of the technology for processing data from the reading device.

### BRIEF DESCRIPTION OF THE DRAWINGS

FIG. 1 is a block diagram of an information processing system according to one embodiment of the present disclosure;

FIG. 2 is a sequence diagram illustrating a first operation of the information processing system; and

FIG. 3 is a sequence diagram illustrating a second operation of the information processing system.

### DETAILED DESCRIPTION

The present disclosure will be described below with reference to certain embodiments.

### (Information Processing System)

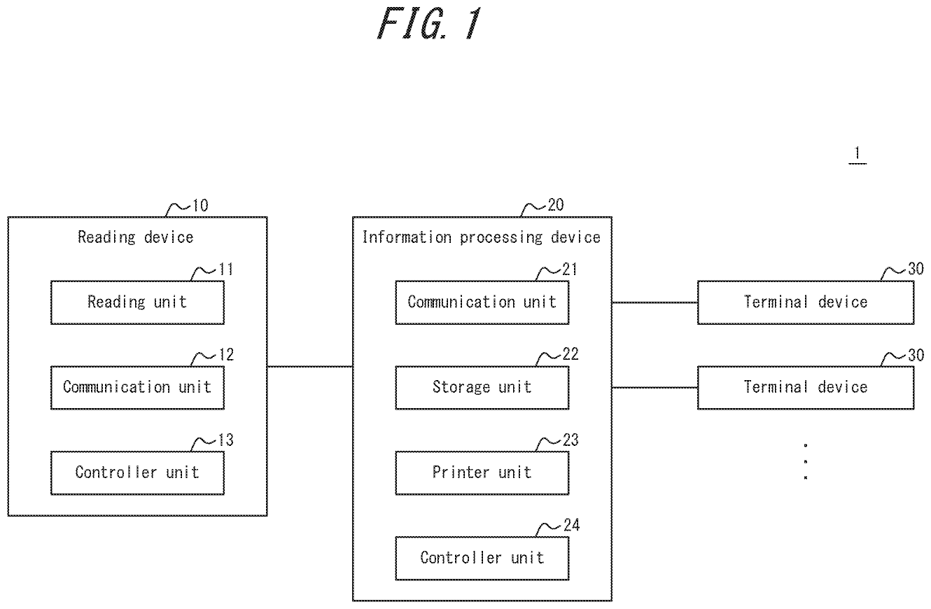

With reference to FIG. 1, the outline of an information processing system 1 according to an embodiment of the present disclosure will be described. The information processing system 1 includes a reading device 10, an information processing device 20, and one or more terminal devices 30. Although FIG. 1 illustrates two terminal devices 30, the number of the terminal device 30 may be arbitrarily determined.

The reading device 10 is a device that reads data stored in an information medium. The information medium may include a one-dimensional code such, as barcode. In such a case, the reading device 10 functions as a barcode scanner. However, the information medium is not limited to a one-dimensional code, and may include any medium having data, such as two-dimensional code. Hereinafter, the data read from one information medium is also referred to as “reading data”. The reading device 10 is communicably connected to the information processing device 20. The reading device 10 transmits the reading data to the information processing device 20.

Each time the information processing device 20 receives the reading data read by the reading device 10, the information processing device 20 stores the reading data. The information processing device 20 is communicably connected to each terminal device 30. The information processing device 20 transmits the stored reading data to the terminal device 30, in response to a request from the terminal device 30.

Here, the information processing device 20 can transmit a plurality of reading data to the terminal device 30, in response to one request from the terminal device 30, as will be described hereinafter. Therefore, as compared for example with a configuration in which one reading data is transmitted for one request, even when a plurality of reading data is stored in the information processing, it is possible to reduce the probability of occurrence of inconvenience, such as increase in number of communications between the terminal device 30 and the operation load of the user using the terminal device 30.

Furthermore, the information processing device 20 may have a printing function. In such a case, the information processing device 20 functions as a network printer. For example, the information processing device 20 serves to print out printing information received from the terminal device 30.

The terminal device 30 has an information processing function. In the present embodiment, a general-purpose device, such as a smartphone, a tablet terminal, or a PC (Personal Computer), is used as the terminal device 30. However, a device dedicated to the information processing system 1 may be used as the terminal device 30. The terminal device 30 transmits a predetermined command to the information processing device 20 as a reading data acquisition request. The terminal device 30 can receive a plurality of reading data transmitted by the information processing device 20, in response to that command. When the information processing device 20 has a printing function, the terminal device 30 can generate printing information and transmit the printing information to the information processing device 20. The printing information may be generated based, for example, on the plurality of reading data as received. The above operations of the terminal device 30 are each executed, for example, by using general purpose software or dedicated software stored in a memory of the terminal device 30. General purpose software includes, for example, a web browser, but is not limited thereto.

The information processing system 1 described above may be used, for example, in a store or the like that sells products. Specifically, each product is provided with an information medium bearing a character string data, such as a product identifier, for example. The shop worker uses the reading device 10 to sequentially read the reading data from the information medium of each product that the customer wants to purchase, for example. Each reading data is stored in the information processing device 20. The operator may operate the terminal device 30 to transmit each reading data from the information processing device 20 to the terminal device 30. The operator may also operate the terminal device 30 to perform a product purchase processing including, for example, payment of fee. When the product purchase processing is completed, printing information, such as the price of each product and the amount paid by the customer, may be transmitted from the terminal device 30 to the information processing device 20. Then, a receipt form on which the printing information is described is printed by the information processing device 20. However, the use mode of the information processing system 1 is not limited to the issuance of a receipt form in a store, and there may be included any mode, such as issuance of a form in inventory management of goods.

### (Reading Device)

The details of the configuration of the reading device 10 will be described below. The reading device 10 includes a reading unit 11, a communication unit 12, and a controller unit 13.

The reading unit 11 includes one or more interfaces that can read an information medium. For example, the reading unit 11 may include an interface that can read a one-dimensional code or a two-dimensional code that constitutes an information medium. The interface includes, for example, a light source for emitting light, and a light receiving element for receiving the light reflected by the information medium. However, the configuration of each interface may be arbitrarily determined depending on the corresponding information medium.

The communication unit 12 includes one or more communication interfaces corresponding to any communication standard. For example, the communication unit 12 may include a communication interface corresponding to a USB (Universal Serial Bus) standard, a wired LAN (Local Area Network) standard such as Ethernet (registered trademark), and a wireless LAN standard such as Wi-Fi (registered trademark). In the present embodiment, the reading device 10 is communicably connected to the information processing device 20 via the communication unit 12.

The controller unit 13 includes one or more processors. In the present embodiment, the processor may include a general purpose processor and a dedicated processor dedicated to a specific processing. The controller unit 13 controls the operation of the entire reading device 10. For example, the controller unit 13 transmits the reading data as read from the information medium by the reading unit 11 to the information processing device 20 via the communication unit 12. Here, the controller unit 13 may transmit the reading data each time the reading data is read.

Alternatively, the controller unit 13 may transmit the two or more of the reading data after they have been read.

### (Information Processing Device)

The details of the configuration of the information processing device 20 are as follows. The information processing device 20 includes a communication unit 21, a storage unit 22, a printer unit 23, and a controller unit 24.

The communication unit 21 includes one or more communication interfaces corresponding to an arbitrary communication standard. For example, the communication unit 21 may include a communication interface corresponding to the USB standard, the wired LAN standard, and the wireless LAN standard, respectively. In the present embodiment, the information processing device 20 is communicably connected to each of the reading device 10 and the terminal device 30 via the communication unit 21. Note that there may be provided a plurality of communication units 21 corresponding to the reading device 10 and the terminal device 30, respectively.

The storage unit 22 includes one or more memories. In the present embodiment, the memory may include, for example, a semiconductor memory, a magnetic memory, an optical memory, and the like. The memory included in the storage unit 22 may each function, for example, as a main storage device, an auxiliary storage device, or a cache memory. The storage unit 22 stores arbitrary information used for the operation of the information processing device 20. In the present embodiment, at least a part of the storage area of the storage unit 22 is used as a buffer area. As will be described hereinafter, the reading data received from the reading device 10 is stored in the buffer area.

The printer unit 23 includes one or more mechanisms for printing information on a print medium. For example, the printer unit 23 may include a transport mechanism for transporting a print medium, such as roll paper or cut print paper, and a print mechanism for printing information on the transported medium. When the print medium is roll paper, the printing unit 23 may further include a cutting mechanism for cutting the medium at a position downstream of the print position. The printing method of the printer unit 23 may be arbitrarily determined, for example, a thermal transfer method or a dot impact method.

The controller unit 24 includes one or more processors. The controller unit 24 controls the operation of the entire information processing device 20. For example, each time the controller unit 24 receives the reading data read by the reading device 10, the controller unit 24 stores the reading data in the buffer area of the storage unit 22.

Furthermore, when a first command is received from the terminal device 30, the controller unit 24 transmits the plurality of reading data stored in the storage unit 22 to the terminal device 30. In the present embodiment, the commands and reading data transmitted and received between the information processing device 20 and the terminal device 30 are described in a markup language, such as XML (Extensible Markup Language), for example, but they may be described in any other format. The controller unit 24 may automatically delete the plurality of reading data transmitted to the terminal device 30 from the buffer area of the storage unit 22.

Here, when the controller unit 24 receives the information designating the conditions of the reading data from the terminal device 30 together with the first command, a plurality of matching reading data matching with the designated conditions, among the two or more of the reading data stored in the storage unit 22, are transmitted to the terminal device 30. The condition of the reading data may be arbitrarily determined. For example, the conditions of the reading data may include an upper limit number of the reading data or an upper limit value of the data size transmitted by the information processing device 20 in response to the reception of the first command. In such a case, the controller unit 24 transmits a plurality of reading data to the terminal device 30 up to the specified number or the data size, among two or more of the reading data stored in the storage unit 22. Also, when the reading data further includes information indicating an attribute in addition to target information (e.g., a product identifier or the like), the conditions of the reading data may include an attribute of the data. The attribute may be arbitrarily determined, for example, the product type or the name of manufacturer. In such a case, the controller unit 24 transmits, to the terminal device 30, a plurality of reading data having a designated attribute among the two or more of the reading data stored in the storage unit 22.

Further, upon receipt of a second command from the terminal device 30, the controller unit 24 operates in accordance with either one of first and second settings, as an operation setting relating to the transmission sequence of the plurality of reading data to be transmitted to the terminal device 30. The first setting is a setting for transmitting a plurality of reading data sequentially from the reading data stored in the storage unit 22 having an earlier timing, such as a queue format. On the other hand, the second setting is a setting in which a plurality of reading data are transmitted sequentially from the reading data stored in the storage unit 22 having a later timing, such as a stack format. According to such a configuration, it is possible for the user to perform the above-described operation setting of the information processing device 20 using the terminal device 30. Here, the controller unit 24 may switch the above-described operation setting regarding the transmission sequence of the plurality of reading data between the first setting and the second setting each time the second command is received from the terminal device 30. Alternatively, the second command may include information for specifying the first setting or the second setting. In such a case, the controller unit 24 performs the setting as designated by the second command.

When a third command is received from the terminal device 30, the controller unit 24 deletes part of, or all the reading data stored in the buffer area of the storage unit 22. According to this configuration, the user can delete the reading data stored in the information processing device 20 using the terminal device 30. Here, the third command may include information indicating the number of reading data to be erased, or information indicating that the erasing target is the entire reading data. In such a case, the controller unit 24 deletes the reading data stored in the buffer area of the storage unit 22, partly or entirely, according to the information included in the third command.

Further, when the controller unit 24 receives a fourth command from the terminal device 30, the controller unit 24 operates in accordance with any one of third through fifth settings, as the operation setting for the case where the reading data is received while the free space in the buffer area of the storage unit 22 is insufficient. The third setting is a setting for erasing all the reading data stored in the buffer area. The fourth setting is a setting for erasing one or more reading data, preferentially from the reading data stored in the buffer area at an earlier timing. Finally, the fifth setting is a setting for erasing one or more reading data, preferentially from the reading data stored in the buffer area at a later timing. According to such a configuration, it is possible for the user to perform the above-described operation settings of the information processing device 20 using the terminal device 30. Here, for example, when the free space in the buffer area is less than a reference value, the controller unit 24 may determine that the free space in the buffer area is insufficient. The reference value may, for example, be a predetermined value or a value determined based on the data size of the received reading data.

Further, when the printing information is received from the terminal device 30, the controller unit 24 controls the printer unit 23 to print out the printing information.

### (Operation Flow of Information Processing System)

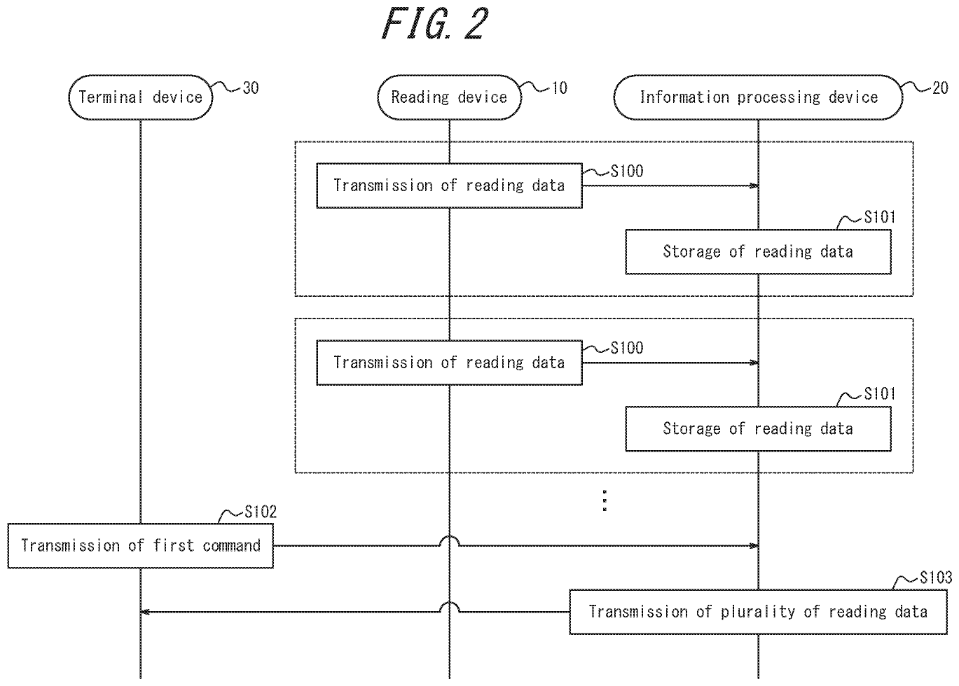

The operation flow of the information processing system 1 will be described below with reference to FIG. 2. The operation includes transmission to the terminal device 30 of a a plurality of reading data stored in the information processing device 20.

Step S100: When the reading data is read from the information medium, the reading device 10 transmits the reading data to the information processing device 20.

Step S101: The information processing device 20 stores the reading data received from the reading device 10 in the buffer area of the storage unit 22.

A plurality of reading data is stored in the information processing device 20 by repeating the abovementioned steps S100 and S101 multiple times. For example, FIG. 2 illustrates an example in which the combination of steps S100 and S101 is executed twice, though the combination may be executed three or more times.

Step S102: The terminal device 30 transmits a first command to the information processing device 20, for example, in response to a user operation.

Step S103: When the first command is received from the terminal device 30, the information processing device 20 transmits the plurality of reading data stored in the buffer area of the storage unit 22 to the terminal device 30.

As described above, the information processing device 20 of the information processing system 1 according to the present embodiment is configured such that, when the first command is received from the terminal device 30, the plurality of reading data stored in the storage unit 22 is transmitted to the terminal device 30. In this way, a plurality of reading data is transmitted in response to one request from the terminal device 30. According to such a configuration, as compared with a configuration in which one reading data is transmitted for one request, for example, even when a plurality of reading data is stored in the information processing device 20, it is possible to reduce the likelihood of inconvenience, such as an increase in number of communications between the processing device 20 and the terminal device 30, or an increase in the operation load of the user who uses the terminal device 30. Therefore, the convenience of the technology for processing the data from the reading device 10 is improved.

Although the present disclosure has been described above with reference to the drawings and embodiments, it should be noted that those skilled in the art can easily make various changes and modifications based on the present disclosure. Therefore, it should be noted that these changes and modifications are included in the scope of the present disclosure. For example, the configuration or function included in each means or each step may be rearranged, or a plurality of means or steps may be combined into one or divided, to the extent logical consistency is preserved.

In the above-described embodiment, for example, at least a part of the configuration and functions of the information processing device 20 may be implemented on another device. At least a part of the configuration and function of the communication unit 21 may be implemented, for example, on an interface board that can be connected to the information processing device 20. Furthermore, at least a part of the configuration and functions of the storage unit 22 may be implemented, for example, in an external storage device that can be connected to the information processing device 20.

In the embodiment described above, after the information processing device 20 receives the first command from the terminal device 30, a standby period may be set corresponding to the terminal device 30. For example, the terminal device 30 may transmit information specifying the time to the information processing device 20 together with the first command. When this information is received together with the first command, the information processing device 20 sets a period from the reception of the first command until the time elapses as a standby period corresponding to the terminal device 30. When the reading data is stored in the buffer area of the storage unit 22 during the standby period, the information processing device 20 also transmits the reading data to the terminal device 30. Here, each of the plurality of reading data may be transmitted each time during the standby period, or the plurality of reading data may be transmitted at the end of the standby period. Specifically, each reading data stored in the buffer area of the storage unit 22 during the standby period may be transmitted to the terminal device 30 each time the reading data is stored in the buffer area, or may alternatively be transmitted to the terminal device 30 in response to completion of the process.

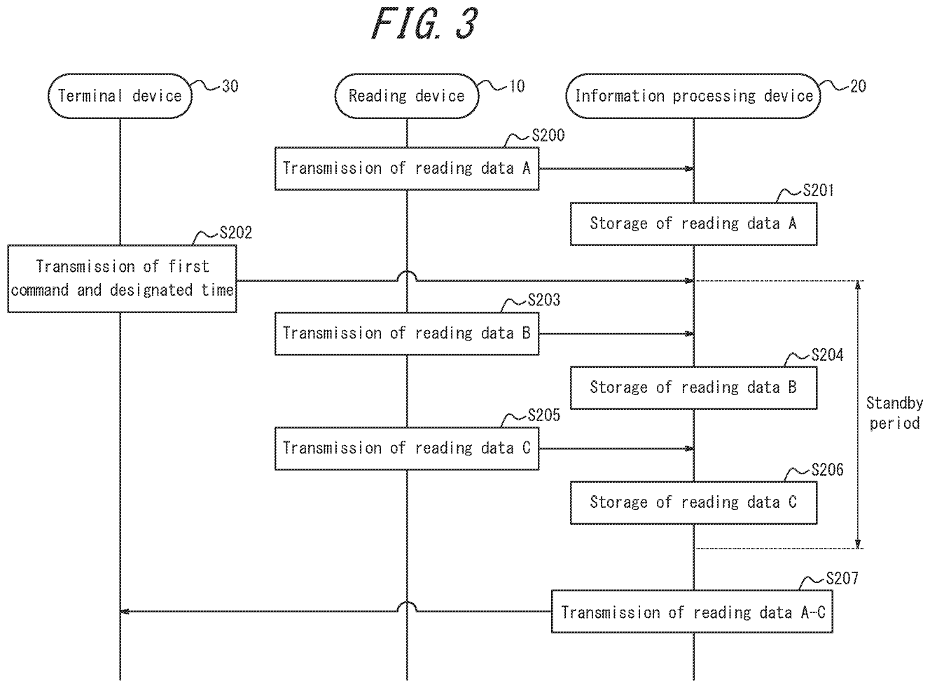

The flow of the second operation of the information processing system 1 will be described with reference to FIG. 3. The second operation includes an operation of transmitting a plurality of reading data to the terminal device 30, using the standby period described above.

Step S200: When the reading data A from the information medium is read, the reading device 10 transmits the reading data A to the information processing device 20.

Step S201: The information processing device 20 stores the reading data A received from the reading device 10 in the buffer area of the storage unit 22.

Step S202: The terminal device 30 transmits the first command and the information specifying the time to the information processing device 20 in response, for example, to a user operation. When the information processing device 20 receives the information together with the first command, the information processing device 20 sets a standby period until the time elapses after reception of the first command.

Step S203: When the reading device 10 reads the reading data B from the information medium during the standby period, the reading device 10 transmits the reading data B to the information processing device 20.

Step S204: The information processing device 20 stores the reading data B received from the reading device 10 in the buffer area of the storage unit 22.

Step S205: When the reading device 10 reads the reading data C from the information medium during the standby period, the reading device 10 transmits the reading data C to the information processing device 20.

Step S206: The information processing device 20 stores the reading data C received from the reading device 10 in the buffer area of the storage unit 22.

Step S207: For example, when the standby period elapses, the information processing device 20 transmits the plurality of reading data A to C stored in the buffer area of the storage unit 22 to the terminal device 30.

FIG. 3 illustrates an example in which the reading data B and C stored in the buffer area of the storage unit 22 during the standby period are collectively transmitted in step S207 in response to termination of the standby period. However, as described above, each of the reading data B and C may be transmitted each time when stored in the buffer area of the storage unit 22. In such a case, for example, the reading data B may be transmitted in step S204, and the reading data C may be transmitted in step S206.

According to the abovementioned configuration using the standby period, even after transmission of the first command by using the terminal device 30, it is possible for a user to read the reading data from the information medium with the reading device 10 during the standby period, and to transmit the reading data from the information processing device 20 to the terminal device 30. Therefore, the convenience of the technology for processing data from the reading device 10 is further improved.

The information processing device 20 may terminate the standby period without waiting for the end of the abovementioned standby period, for example, in response to a request from another terminal device 30. According to such a configuration, subsequently to a user using the terminal device 30, another user using another terminal device 30 can quickly use the information processing device 20. Therefore, the convenience of the technology for processing data from the reading device 10 is further improved.

### REFERENCE SIGNS LIST

1 Information processing system
10 Reading device
11 Reading unit
12 Communication unit
13 Controller unit
20 Information processing device
21 Communication unit
22 Storage unit
23 Printer unit
24 Controller unit
30 Terminal device

1. An information processing device having a communication function, comprising:
a controller unit configured to store reading data in a storage unit each time the reading data read by a reading device is received, and to transmit a plurality of the reading data stored in the storage unit to a terminal device when a first command is received from the terminal device.

2. The information processing device according to claim 1, wherein,
the controller unit is configured to, when a second command is received from the terminal device, operate in accordance with a first setting or a second setting as an operation setting relating to the transmission sequence of the plurality of the reading data;
the first setting is for transmitting the plurality of the reading data sequentially from the reading data stored in the storage unit at an earlier timing; and
the second setting is for transmitting the plurality of the reading data sequentially from the reading data stored in the storage unit at a later timing.

3. The information processing device according to claim 1, wherein,
the controller unit is configured to, when a third command is received from the terminal device, delete a part of, or all the reading data stored in the storage unit.

4. The information processing device according to claim 1, wherein:
the controller unit is configured to store the reading data in a buffer area of the storage device;
the controller unit is configured to, when a fourth command is received from the terminal device, operate in accordance with a third setting, a fourth setting, or a fifth setting as an operation setting for the case where the reading data is received when the free space in the buffer area is insufficient;
the third setting is for erasing all the reading data stored in the buffer area;
the fourth setting is for erasing one or more of the reading data, preferentially from the reading data stored in the buffer area at an earlier timing; and
the fifth setting is for erasing one or more of the reading data, preferentially from the reading data stored in the buffer area at a later timing.

5. The information processing device according to claim 1, wherein,
the controller unit is configured to, when information designating a condition of the reading data is received together with the first command, transmit to the terminal device the plurality of reading data that meet the designated condition, among the two or more of the reading data stored in the storage unit.

6. The information processing device according to claim 1, wherein,
the controller is configured to, when information designating a time is received together with the first command, set period until said time elapses after receipt of the first command, and transmit the plurality of reading data to the terminal device, including at least the reading data stored in the storage unit during said period.

7. The information processing device according to claim 6, wherein
the controller unit is configured to cancel the set period in response to a request from another terminal device.

8. The information processing device according to claim 6, wherein
the controller unit is configured to transmit the reading data stored in the storage unit during the set period to the terminal device, each time the reading data is stored in the storage unit, or in response to termination of the period.

9. An information processing system comprising a reading device and an information processing device having a communication function, wherein:
the reading device is configured to read reading data and transmit the reading data to the information processing device; and
the information processing device is configured to store reading data in a storage unit each time the reading data is received, and to transmit a plurality of the reading data stored in the storage unit to a terminal device when a first command is received from the terminal device.

10. An information processing method executable by an information processing device having a communication function, the method comprising:
storing reading data in a storage unit each time the reading data read by a reading device is received; and
transmitting a plurality of the reading data stored in the storage unit to a terminal device when a first command is received from the terminal device.
